(19) United States
(12) Patent Application Publication
(10) Pub. No.: US 2023/0289840 A1
(43) Pub. Date: Sep. 14, 2023

(54) SERVER AND METHOD OF DETERMINING A FEE SURGE FOR AN ON-DEMAND SERVICE

(71) Applicant: GRABTAXI HOLDINGS PTE. LTD., Singapore (SG)

(72) Inventors: Wentong LI, Singapore (SG); Jialin LIU, Singapore (SG); Renrong WENG, Singapore (SG); Roy Hao Qiang ZHANG, Singapore (SG); Chun Kai PHANG, Singapore (SG)

(21) Appl. No.: 18/012,524

(22) PCT Filed: Jul. 7, 2021
(86) PCT No.: PCT/SG2021/050394

§ 371 Date: Dec. 22, 2022

(30) Foreign Application Priority Data
Aug. 7, 2020 (SG) 10202007592P

(51) Int. Cl. G06Q 30/0201; G06Q 50/30

(52) U.S. Cl. CPC G06Q 30/0206; G06Q 50/30

(57) ABSTRACT

A server configured to determine a fee surge for an on-demand service may include processor(s) that may perform the following upon receiving each request for the service: determine, from the request, a location where the service is required; determine, using a map from the memory, a supply area around the location; determine the surge based on the supply area; compare the surge with a surge lower bound for the supply area and set it as this bound if it is lower than this bound; communicate the surge to the respective requestor computing device and a provider computing device; and allocate the associated service provider to fulfil the request if both the service requestor and service provider accept the surge. The surge lower bound may be based on historical allocation rates, each representing a number of fulfilled requests at a fee surge during historical time interval(s) in a characteristically similar area.

### TECHNICAL FIELD

Various aspects of this disclosure relate to a server configured to determine a fee surge for an on-demand service. Various aspects of this disclosure relate to a method of determining a fee surge for an on-demand service. Various aspects of this disclosure relate to a non-transitory computer-readable medium storing computer executable code including instructions for determining a fee surge for an on-demand service. Various aspects of this disclosure relate to a computer executable code including instructions for determining a fee surge for an on-demand service.

### BACKGROUND

There are currently many types of on-demand services such as transportation services and food delivery services. An on-demand service is typically provided via a platform that allows a consumer to request for the service as and when it is required. The platform links the consumer (service requestor) with a service provider that is available to provide the on-demand service at the required location and time.

At present, several platforms providing on-demand services utilize surge pricing to balance demand and supply of the services. In particular, a surge in the fee (in other words, a fee surge) may be imposed on the consumer if the service is required at a time or location where the demand for the service greatly exceeds the number of service providers available to provide the service. The fee surge may be presented to the consumer and the consumer can then choose to accept or reject the provision of the service at the fee surge. Similarly, a service provider can also decide whether to accept or reject providing the service, in view of the fee surge or other factors such as the consumer's location.

The utilization of surge pricing tends to cause collusion among the service providers, as they exploit this mechanism to maximize their profits. Such collusion is possible as service providers of on-demand services can usually be considered as close to perfect substitutes of one another. For example, a consumer's experience of an on-demand transportation service may not differ by much regardless of the driver providing the service, as long as the driver is within a certain proximity of the consumer.

There are many ways a service provider can influence the inputs to currently available surge pricing mechanisms, so as to adjust the output to their advantage. These inputs may include, for example, supply signals/occupancy rates (indicating the number of available service providers) and demand signals/allocation rates (indicating the proportion of service requests fulfilled). For instance, multiple drivers providing an on-demand transportation service can collude to collectively toggle between being available (“online”) and not available (“offline”), thus creating an artificial supply shortage. In particular, it has been observed that a higher percentage of rides tends to be assigned to drivers who toggle between being available and not available. Each driver can also make changes to certain features of his/her interface to the platform to avoid being assigned certain service requests. For example, the driver may change the “Auto-Accept” feature to avoid automatically accepting service requests and/or the “My Destination” feature to hinder the platform from determining his/her true location. Further, the driver can reject service requests with fee surges lower than his/her expectations, thus affecting the allocation rates.

The collusion of the service providers not only results in the surge pricing mechanism being unable to balance the real demand and supply of the service, it also causes instability in the surge pricing mechanism. In particular, as the drivers tend to display the above-mentioned collusion behavior over a short duration, the fee surge often fluctuates greatly over time. For example, the drivers may collude to become “offline” at approximately a same time, causing the occupancy rates to increase and the allocation rates to decrease (as more requests for the service cannot be fulfilled) and the surge to increase. Soon after this increase in surge, the drivers may collectively become “online” to accept the service requests. This may then cause the occupancy rates to decrease and the allocation rates to increase and in turn, the surge to decrease. Such fluctuation (or in other words, surge oscillation) may consume more platform resources and reduce the speed of operation in the platform. Surge oscillation may also lower the overall allocation rate, increase the overall cancellation rate, and decrease the speed of assigning and allocating a service provider to a service request, in turn reducing the total revenue of each service provider.

### SUMMARY

Therefore, there may be a need to provide an improved surge pricing mechanism with a reduced surge oscillation. There may also be a need to reduce the motivation of the service providers to collude to exploit the surge pricing mechanism in a manner that may cause surge oscillation.

Various embodiments may provide a server configured to determine a fee surge for an on-demand service. The server may include one or more processor(s) configured to receive a plurality of requests for the on-demand service from respective requestor computing devices associated with respective service requestors and further configured to receive service provider data from a plurality of provider computing devices associated with respective service providers. The server may further include a memory having a map and instructions stored therein. The instructions when executed by the one or more processor(s), may cause the one or more processor(s) to perform the following upon receiving each request for the on-demand service: determine, from the request for the on-demand service, a location where the on-demand service is required; determine, using the map stored in the memory, a supply area around the location where the on-demand service is required; determine the fee surge based on the supply area; compare the fee surge with a surge lower bound for the supply area and set the fee surge as the surge lower bound upon determining that the fee surge is lower than the surge lower bound; communicate the fee surge to the respective requestor computing device and to a provider computing device for the associated service requestor and the associated service provider to indicate whether to accept provision of the service at the fee surge; and allocate the associated service provider to fulfil the request at the fee surge upon receiving indication that both the associated service requestor and the associated service provider accept the provision of the service at the fee surge. The surge lower bound for the supply area may be determined based on a plurality of historical allocation rates. Each historical allocation rate may correspond to a respective fee surge and may be representative of a number of fulfilled requests at the respective fee surge during one or more historical time intervals in an area characteristically similar to the supply area.

According to various embodiments, the one or more processor(s) may further determine, from the request for the on-demand service, a time interval of interest during which the on-demand service is required. The one or more historical time intervals for each historical allocation rate may be characteristically similar to the time interval of interest.

According to various embodiments, the one or more historical time intervals for each historical allocation rate may include a first set of historical time intervals having a first characteristic similar to the time interval of interest and a second set of historical time intervals having a second characteristic similar to the time interval of interest. The first characteristic may differ from the second characteristic.

According to various embodiments, each historical allocation rate may be determined by: determining a first rate using the number of fulfilled requests at the respective fee surge during the first set of time intervals; determining a second rate using the number of fulfilled requests at the respective fee surge during the second set of time intervals; and determining the historical allocation rate using a weighted function of the first rate and the second rate.

According to various embodiments, the surge lower bound for the supply area may be determined as a minimum of the fee surges corresponding to the historical allocation rates above a percentile threshold.

According to various embodiments, the map stored in the memory may include a plurality of geohashes and the supply area may be determined as the geohash within which the location where the on-demand service is required lies.

According to various embodiments, for each geohash, a surge value may be periodically determined. The surge value may be determined at a particular time point based on a number of available provider computing devices associated with service providers available to provide the on-demand service and located within the geohash at the particular time point. The fee surge may be set as the most recently determined surge value for the supply area.

According to various embodiments, the memory may further include a size parameter stored therein. The size parameter may indicate a particular dimension of the supply area and the supply area may be determined, using the size parameter, as an area having the particular dimension and centered around the location where the on-demand service is required.

According to various embodiments, the fee surge may be determined based on the supply area by: determining, using the service provider data, a number of available provider computing devices associated with service providers available to provide the on-demand service and located within the supply area; determining a surge value based on the number of available provider computing devices; and setting the fee surge as the surge value.

According to various embodiments, the supply area may be a circular area and the size parameter may indicate a radius of the supply area.

According to various embodiments, the surge value which the fee surge may be set as, may be determined using a weighted function of the number of available provider computing devices. The weighted function may include weights associated with respective available provider computing devices. Each weight may be related to a distance between a location of the associated available provider computing device and a center of the supply area.

According to various embodiments, the one or more processor(s) may be further configured to periodically receive updated service provider data such that the updated service provider data may be received at each time instance of a plurality of successive time instances. The memory may be configured to store the received service provider data at each time instance. The request for the on-demand service may be received at a particular time. The fee surge may be determined based on the service provider data received at the most recent time instance nearest to the particular time the request may be received and the service provider data received at one or more time instances prior to the most recent time instance.

According to various embodiments, the fee surge may be determined using a weighted function of the service provider data received at the most recent time instance and the service provider data received at each of the one or more time instances prior to the most recent time instance.

In various embodiments, the weighted function may include weights associated with respective time instances. Each weight may be related to a difference between the respective time instance and the most recent time instance.

In various embodiments, the on-demand service may include an on-demand transportation service.

Various embodiments may provide a method of determining a fee surge for an on-demand service. The method may include using one or more processor(s) of a server to: receive a plurality of requests for the on-demand service from respective requestor computing devices associated with respective service requestors; receive service provider data from a plurality of provider computing devices associated with respective service providers; and perform the following upon receiving each request for the on-demand service: determine, from the request for the on-demand service, a location where the on-demand service is required; determine, using the map stored in the memory, a supply area around the location where the on-demand service is required; determine the fee surge based on the supply area; compare the fee surge with a surge lower bound for the supply area and set the fee surge as the surge lower bound upon determining that the fee surge is lower than the surge lower bound; communicate the fee surge to the respective requestor computing device and to a provider computing device for the associated service requestor and the associated service provider to indicate whether to accept provision of the service at the fee surge; allocate the associated service provider to fulfil the request at the fee surge upon receiving indication that both the associated service requestor and the associated service provider accept the provision of the service at the fee surge. The surge lower bound for the supply area may be determined based on a plurality of historical allocation rates. Each historical allocation rate may correspond to a respective fee surge and may be representative of a number of fulfilled requests at the respective fee surge during one or more historical time intervals in an area characteristically similar to the supply area.

Various embodiments may provide a non-transitory computer-readable medium storing computer executable code including instructions for determining a fee surge for an on-demand service according to the various embodiments disclosed herein.

Various embodiments may provide a computer executable code including instructions for determining a fee surge for an on-demand service according to the various embodiments disclosed herein.

Various embodiments may provide a server configured to determine a fee surge for an on-demand service. The server may include one or more processor(s) configured to receive a plurality of requests for the on-demand service from respective requestor computing devices associated with respective service requestors and further configured to receive service provider data from a plurality of provider computing devices associated with respective service providers. The server may further include a memory having a size parameter, a map and instructions stored therein. The instructions when executed by the one or more processor(s), may cause the one or more processor(s) to perform the following upon receiving each request for the on-demand service: determine, from the request for the on-demand service, a location where the on-demand service is required; determine, using the map and the size parameter stored in the memory, a supply area having a particular dimension indicated by the size parameter and centered around the location where the on-demand service is required; determine, using the service provider data, a number of available provider computing devices associated with service providers available to provide the on-demand service and located within the supply area; determine a surge value based on the number of available provider computing devices and set the fee surge as the surge value; communicate the fee surge to the respective requestor computing device and to a provider computing device for the associated service requestor and the associated service provider to indicate whether to accept provision of the service at the fee surge; and allocate the associated service provider to fulfil the request at the fee surge upon receiving indication that both the associated service requestor and the associated service provider accept the provision of the service at the fee surge.

According to various embodiments, the supply area may be a circular area and the size parameter stored in the memory may indicate a radius of the supply area.

According to various embodiments, the supply area may be reduced in size upon determining that the number of available computing provider devices within the supply area is greater than a maximum supply threshold.

Various embodiments may provide a server configured to determine a fee surge for an on-demand service. The server may include one or more processor(s) configured to receive a plurality of requests for the on-demand service from respective requestor computing devices associated with respective service requestors; and further configured to receive service provider data from a plurality of provider computing devices associated with respective service providers, where updated service provider data may be received at each time instance of a plurality of successive time instances. The server may further include a memory configured to store the received service provider data at each time instance. The memory may have a map and instructions stored therein. The instructions when executed by the one or more processor(s), may cause the one or more processor(s) to perform the following upon receiving a request for the on-demand service at a particular time: determine, from the request for the on-demand service, a location where the on-demand service is required; determine, using the map stored in the memory, a supply area around the location where the on-demand service is required; determine the fee surge based on the supply area, the service provider data received at the most recent time instance nearest to the particular time the request is received and the service provider data received at one or more time instances prior to the most recent time instance; communicate the fee surge to the respective requestor computing device and to a provider computing device for the associated service requestor and the associated service provider to indicate whether to accept provision of the service at the fee surge; and allocate the associated service provider to fulfil the request at the fee surge upon receiving indication that both the associated service requestor and the associated service provider accept the provision of the service at the fee surge.

To the accomplishment of the foregoing and related ends, the one or more embodiments include the features hereinafter fully described and particularly pointed out in the claims. The following description and the associated drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The invention will be better understood with reference to the detailed description when considered in conjunction with the non-limiting examples and the accompanying drawings, in which:

FIG. 1 shows a surface graph of a surge delta as a function of a gaming ratio and a supply state ratio;

FIG. 2 shows a schematic diagram of a communication system 200 according to various embodiments;

FIG. 3 shows a flowchart of a method of determining a fee surge for an on-demand service according to various embodiments;

FIG. 4 shows an example determination of a supply area in a map, around a location where the on-demand service is required;

FIG. 5 shows a flowchart of a part of the method of FIG. 3 according to various embodiments;

FIG. 6 shows an example determination of another supply area in the map of FIG. 4, around another location where the on-demand service is required;

FIG. 7 shows a graph illustrating an output of a weighted function with weights associated with respective available provider computing devices and related to the distances between these available provider computing devices and a center of the supply area;

FIGS. 8A and 8B respectively show an actual number of available provider computing devices and an exponentially weighted average number of available provider computing devices over a time period;

FIG. 9 shows a flowchart of a method of determining a fee surge for an on-demand service according to alternative embodiments; and

FIG. 10 shows an example of setting a surge lower bound based on historical allocation rates.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the systems or server or methods or computer program are analogously valid for the other systems or server or methods or computer program or vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

The word “exemplary” is used herein to mean “serving as an example, instance, or illustration.” Any embodiment or design described herein as “exemplary” is not necessarily to be construed as preferred or advantageous over other embodiments or designs.

In the context of various embodiments, the articles “a”, “an” and “the” as used with regard to a feature or element include a reference to one or more of the features or elements.

As used herein, the term “and/or” includes any and all combinations of one or more of the associated listed items.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The words “plural” and “multiple” in the description and the claims expressly refer to a quantity greater than one. Accordingly, any phrases explicitly invoking the aforementioned words (e.g. “a plurality of [objects]”, “multiple [objects]”) referring to a quantity of objects expressly refers more than one of the said objects. The terms “group (of)”, “set [of]”, “collection (of)”, “series (of)”, “sequence (of)”, “grouping (of)”, etc., and the like in the description and in the claims, if any, refer to a quantity equal to or greater than one, i.e. one or more. The terms “proper subset”, “reduced subset”, and “lesser subset” refer to a subset of a set that is not equal to the set, i.e. a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term data, however, is not limited to the aforementioned examples and may take various forms and represent any information as understood in the art.

The term “processor” or “controller” as, for example, used herein may be understood as any kind of entity that allows handling data, signals, etc. The data, signals, etc. may be handled according to one or more specific functions executed by the processor or controller.

A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “system” (e.g., a drive system, a position detection system, etc.) detailed herein may be understood as a set of interacting elements, the elements may be, by way of example and not of limitation, one or more mechanical components, one or more electrical components, one or more instructions (e.g., encoded in storage media), one or more controllers, etc.

A “circuit” as used herein is understood as any kind of logic-implementing entity, which may include special-purpose hardware or a processor executing software. A circuit may thus be an analog circuit, digital circuit, mixed-signal circuit, logic circuit, processor, microprocessor, Central Processing Unit (“CPU”), Graphics Processing Unit (“GPU”), Digital Signal Processor (“DSP”), Field Programmable Gate Array (“FPGA”), integrated circuit, Application Specific Integrated Circuit (“ASIC”), etc., or any combination thereof. Any other kind of implementation of the respective functions which will be described below in further detail may also be understood as a “circuit.” It is understood that any two (or more) of the circuits detailed herein may be realized as a single circuit with substantially equivalent functionality, and conversely that any single circuit detailed herein may be realized as two (or more) separate circuits with substantially equivalent functionality. Additionally, references to a “circuit” may refer to two or more circuits that collectively form a single circuit.

As used herein, “memory” may be understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, it is appreciated that registers, shift registers, processor registers, data buffers, etc., are also embraced herein by the term memory. It is appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

As used herein, the term “geohash” may be predefined geocoded cells of partitioned areas of a city or country.

According to various embodiments, a fee surge for an on-demand service may be determined using a PI control with dead-zone and new signals model. In this model, a gaming ratio rₜ at a time instance t may be defined according to Equation (1) below.

$${r}_{t} = \frac{{S}_{t}^{gaming}}{{S}_{t}^{available}} \qquad ( 1 )$$

where Sₜ^{available} represents a number of service providers available to provide the service and are not fulfilling any service request at the time instance t and Sₜ^{gaming} represents a number of gaming service providers, or in other words, service providers who have made themselves unavailable to provide the service (by, for example, going “offline”) in an attempt to influence the surge to their advantage.

A supply state ratio may also be defined according to Equation (2) below.

$${q}_{t} = \frac{{S}_{t}^{occupied}}{{S}_{t}^{available}} \qquad ( 2 )$$

where Sₜ^{occupied} represents the number of service providers providing the service (or in other words, fulfilling service requests) at the time instance t.

An instant one-step surge delta Δsₜ (or in other words, a change in the surge) at a current time instance t may then be determined using Equation (3) as shown below. The successive time instances t and t−1 may be spaced apart by a time interval such as one minute.

$$\begin{matrix}Δ {s}_{t} = {fs}_{t} = {k}_{P}^{o} ( {e}_{t}^{o} - {e}_{t - 1}^{o} ) \\ = {k}_{P}^{o} ( {y}_{t - 1}^{o} - {y}_{t}^{o} ) \\ \approx {k}_{P}^{o} ( \frac{{S}_{t - 1}^{occupied}}{{S}_{t - 1}^{occupied} + {S}_{t - 1}^{available}} - \frac{{S}_{t}^{occupied}}{{S}_{t}^{occupied} + {S}_{t}^{available} - {S}_{t}^{gaming}} ) \\ = {k}_{P}^{o} ( \frac{{q}_{t - 1}}{{q}_{t - 1} + 1} - \frac{{q}_{t}}{{q}_{t} + 1 - {r}_{t}} )\end{matrix} \qquad ( 3 )$$

where ƒsₜ represents a function of the fee surge sₜ, yₜ₋₁^{o}, yₜ^{o} represent occupancy rates, k_{P}^{o} represents a surge controller parameter where k_{P}^{o}<0, and eₜ^{o}, eₜ₋₁^{o} represent differences between desired and actual occupancy rates.

The surge oscillation ω(sₜ) may be determined using Equation (4) below.

$$ω ( {s}_{t} ) = {max}_{n = t - 4 , … t} {s}_{n} - {min}_{n = t - 4 , … t} {s}_{n} \qquad ( 4 )$$

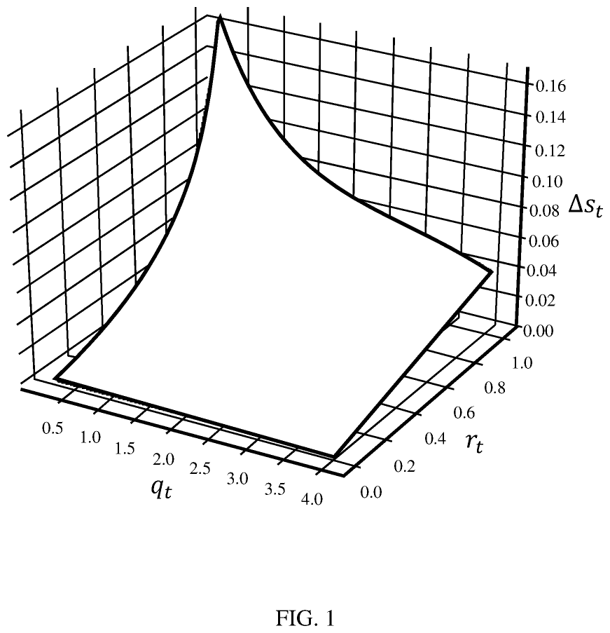

FIG. 1 shows a surface graph of the surge delta Δsₜ according to various embodiments. As shown in FIG. 1, as the proportion of gaming service providers increases (in other words, as the gaming ratio rₜ increases), yₜ^{o} may increase. Therefore, Δsₜ may be positive and the surge sₜ may increase, causing an artificial increase in the surge sₜ due to the behavior of the gaming service providers.

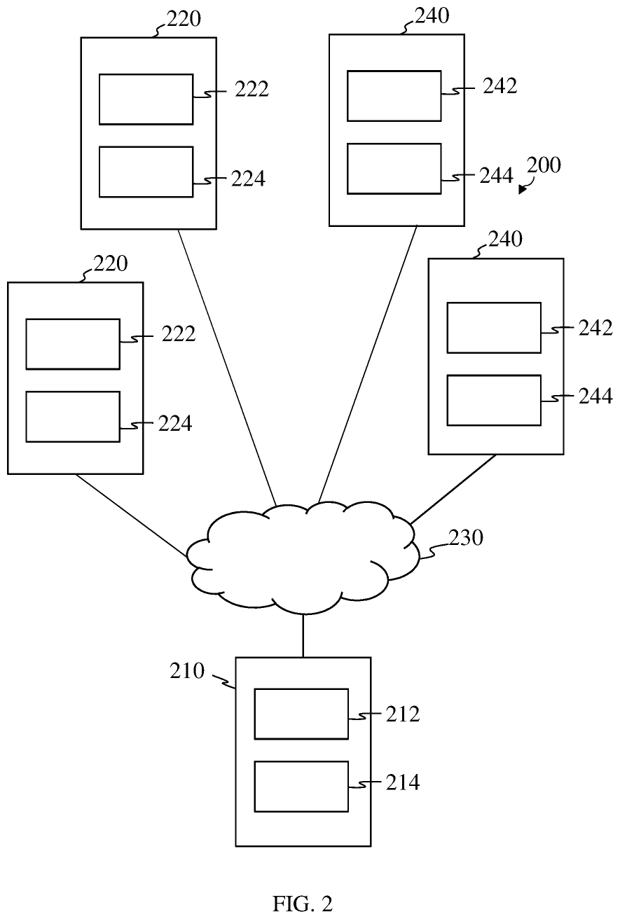

FIG. 2 shows a schematic diagram of a communication system 200 according to various embodiments.

According to various embodiments, the communication system 200 may include a server 210, and/or a plurality of requestor computing devices 220 associated with respective service requestors and/or a plurality of provider computing devices 240 associated with respective service providers. Although only two requestor computing devices 220 and two provider computing devices 240 are shown in FIG. 2, it is understood that there may be more requestor computing devices 220 and provider computing devices 240.

In some embodiments, the server 210 and the requestor computing devices 220 may be in communication with each other through the communication network 230. The server 210 and the provider computing devices 240 may also be in communication with each other through the communication network 230. Even though FIG. 2 shows a line connecting the server 210 to the communication network 230, a line connecting each requestor computing device 220 to the communication network 230, and a line connecting each provider computing device 240 to the communication network 230, the server 210, each requestor computing device 220 and each provider computing device 240 need not be physically connected to each other. Instead, the server 210, each requestor computing device 220 and each provider computing device 240 may be able to communicate wirelessly through the communication network 230 by internet communication protocols or through a mobile cellular communication network.

In various embodiments, the server 210 may be a single server as illustrated schematically in FIG. 2, or have the functionality performed by the server 210 distributed across multiple server components. The server 210 may include one or more server processor(s) 212. The various functions performed by the server 210 may be carried out by the one or more server processor(s) 212. In some embodiments, the various functions performed by the server 210 may be carried out across the one or more server processor(s) 212. In other embodiments, each specific function of the various functions performed by the server 210 may be carried out by specific server processor(s) 212 of the one or more server processor(s) 212.

In some embodiments, the server 210 may include a memory 214. The server 210 may also include a database. The memory 214 and the database may be one component or may be separate components. The memory 214 of the server may include computer executable code defining the functionality that the server 210 carries out under control of the one or more server processor(s) 212. The database and/or memory 214 may include historical data of past on-demand service, e.g., a pick-up location and/or drop-off location, and/or fee and/or time. The memory 214 may include or may be a computer program product such as a non-transitory computer-readable medium.

According to various embodiments, a computer program product may store the computer executable code including instructions for determining a fee surge for an on-demand service according to various embodiments. The computer executable code may be a computer program. The computer program product may be a non-transitory computer-readable medium. The computer program product may be in the communication system 200 and/or the server 210.

In some embodiments, the server 210 may also include an input and/or output module allowing the server 210 to communicate over the communication network 230. The server 210 may also include a user interface for user control of the server 210. The user interface may include, for example, computing peripheral devices such as display monitors, user input devices, for example, touchscreen devices and computer keyboards.

In various embodiments, each requestor computing device 220 may include a requestor computing device memory 222 and a requestor computing device processor 224. The requestor computing device memory 222 may include computer executable code defining the functionality the requestor computing device 220 carries out under control of the requestor computing device processor 224. The requestor computing device memory 222 may include or may be a computer program product such as a non-transitory computer-readable medium. The requestor computing device 220 may also include an input and/or output module allowing the requestor computing device 220 to communicate over the communication network 230. The requestor computing device 220 may also include a user interface for the service requestor to control the requestor computing device 220. The user interface may be a touch panel display. The user interface may include a display monitor, a keyboard or buttons.

In various embodiments, the provider computing device 240 may include a provider computing device memory 242 and a provider computing device processor 244. The provider computing device memory 242 may include computer executable code defining the functionality the provider computing device 240 carries out under control of the provider computing device processor 244. The provider computing device memory 242 may include or may be a computer program product such as a non-transitory computer-readable medium. The provider computing device 240 may also include an input and/or output module allowing the provider computing device 240 to communicate over the communication network 230. The provider computing device 240 may also include a user interface for the service provider to control the provider computing device 240. The user interface may be a touch panel display. The user interface may include a display monitor, a keyboard or buttons.

In various embodiments, the server 210 may be configured to determine a fee surge for an on-demand service. The on-demand service may include any type of service, such as, but not limited to, an on-demand transportation service and an on-demand food delivery service. In some embodiments, the one or more processor(s) 212 of the server 210 may receive a plurality of requests for the on-demand service from respective requestor computing devices 220 associated with respective service requestors. Each request for the on-demand service may include location data. The location data may indicate a location where the on-demand service is required. Each request for the on-demand service may further include other data, for example, time data indicating a time interval of interest during which the on-demand service is required or any other data related to the service. In some embodiments, the one or more processor(s) 212 of the server 210 may receive service provider data from a plurality of provider computing devices 240 associated with respective service providers within the geographical region where the on-demand service may be provided. The service provider data from each provider computing device 240 may include an availability indicator indicating whether the service provider associated with the provider computing device 240 is available to provide the on-demand service. The service provider data from each provider computing device 240 may further include location data indicating a location of the service provider. In some embodiments, the location data in each request for the service and the location data in the service provider data may include location coordinates in a same predefined coordinate system (for example, the global positioning system (GPS)). The memory 214 of the server 210 may include a map stored therein, where the map may have the same predefined coordinate system as the location data in the requests for the service and the service provider data. In various embodiments, while each request for the on-demand service may be received by the server 210 as and when a user requires the service, the one or more processor(s) 212 of the server 210 may receive updated service provider data periodically, or in other words, in each time instance tₛₚ of a plurality of successive time instances. At each time instance tₛₚ, the service provider data may be received by the one or more processor(s) 212 from all the provider computing devices 240 that are “online” and within the geographical region where the service can be provided. The memory 214 of the server 210 may store the received service provider data at each time instance tₛₚ. In some embodiments, the memory 214 may be capable of storing only a limited amount of service provider data. For example, the memory 214 may be capable of storing only service provider data in the past y number of time instances. In this example, after storing the service provider data for y number of time instances, the service provider data in the earliest time instance may be deleted from the memory 214 before the service provider data in the next time instance is stored, so that at each time instance, the amount of service provider data available in the memory 214 may be at most over y number of time instances.

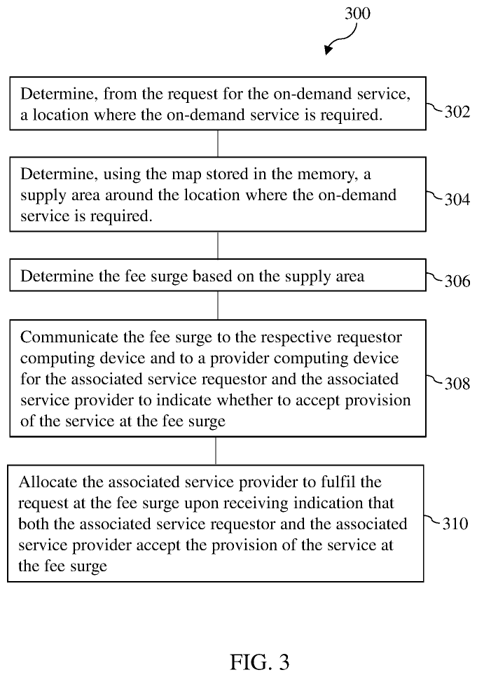

FIG. 3 shows a flowchart of a method 300 according to various embodiments.

According to various embodiments, the method 300 of determining a fee surge for an on-demand service may be provided. In some embodiments, the memory 214 of the server 210 may include instructions stored therein, the instructions when executed by the one or more processor(s) 212 of the server 210, may cause the one or more processor(s) 212 to perform method 300 upon receiving each request for the on-demand service. As shown in FIG. 3, the method 300 may include 302-310. Although FIG. 3 shows 302-310 in a specific order, other arrangements are possible and any suitable order of 302-310 may be used. Further, two or more of 302-310 in FIG. 3 may be combined.

The method 300 will now be described in detail below with reference to FIG. 3.

Referring to FIG. 3, the method 300 may include determining (at 302) a location where the on-demand service is required. In various embodiments, the location where the on-demand service is required may be determined from the request for the on-demand service. For example, the request may include location data (such as, but not limited to, location coordinates) and the location where the on-demand service is required may be determined by extracting the location data from the request.

Referring to FIG. 3, the method 300 may further include determining (at 304) a supply area around the location where the on-demand service is required. As mentioned above, in some embodiments, the memory 214 of the server 210 may include a map stored therein and in these embodiments, the supply area may be determined using the map stored in the memory 214. In some embodiments, location coordinates of a boundary of the supply area may be determined.

In some embodiments, a geographical region (e.g. a city) in which the on-demand service may be provided may be divided into a plurality of geohashes. Therefore, the map stored in the memory 214 may include a plurality of geohashes. In these embodiments, at 304 of method 300, the supply area may be determined as the geohash within which the location where the on-demand service is required lies.

In alternative embodiments, the memory 214 of the server 210 may further include a size parameter stored therein, where the size parameter may indicate a particular dimension of the supply area. In these embodiments, the supply area may be determined, using the size parameter, as an area having the particular dimension and centered around the location where the on-demand service is required. Such a supply area may be larger than a typical geohash used in current platforms providing on-demand services. For example, a typical geohash may be approximately 0.73 km² in size, whereas in some embodiments, the size of the supply area determined at 304 may range from about two to about three times the size of the typical geohash, for example, about 1.4 km² to about 2.5 km². In some embodiments, the supply area may be a circular area and the size parameter may indicate a radius of the supply area. However, the supply area may be in other shapes and the size parameter may indicate other types of dimensions such as, but not limited to, a length, breadth, or area.

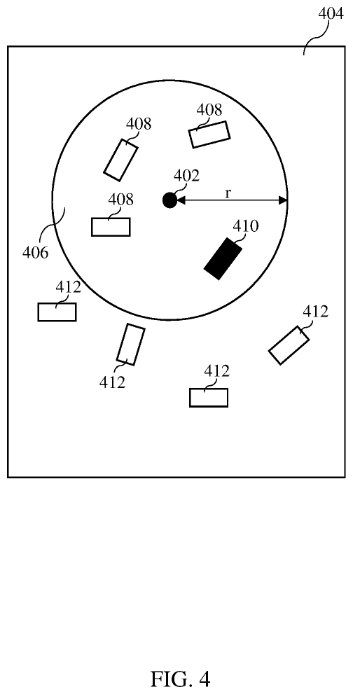

FIG. 4 shows an example determination of a supply area 406 centered around a location 402 where the on-demand service is required. The location 402 may be extracted from the request for the on-demand service and may first be located in a map 404 retrieved from the memory 214. The supply area 406 may then be determined as a circular area having a particular radius r (and hence, a size πr²) centered around the location 402, where the value of r may be the dimension indicated by the size parameter from the memory 214. In some embodiments, the radius r may be a maximum broadcast radius of the geographical region. For example, the geographical region may be Singapore and the radius r may be about 2.5 km and accordingly, the supply area may have a size of about 19.63 km².

Referring to FIG. 3, the method 300 may further include determining (at 306) the fee surge based on the supply area.

In some embodiments where the geographical area may be divided into a plurality of geohashes, a surge value may be periodically determined for each geohash. The surge value determined at a particular time point x may be determined based on a number of available provider computing devices 240 (associated with service providers available to provide the on-demand service and located within the geohash) at the particular time point x. This may be determined from the most recently received service provider data. As mentioned above, in such embodiments, the supply area may be determined as the geohash within which the location where the on-demand service is required lies and accordingly, the fee surge may be set as the most recently determined surge value for the supply area. Further, the available provider computing devices 240 for the request may be determined as the available provider computing devices 240 used for determining this most recent surge value for the supply area.

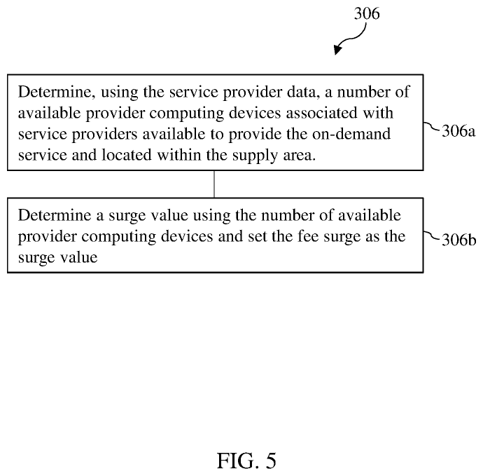

In alternative embodiments where the supply area may be determined using the size parameter in the memory 214, 306 of method 300 may be performed using 306a and 306b as shown in FIG. 5.

In particular, at 306a, a number of available provider computing devices 240 (associated with service providers available to provide the on-demand service and located within the supply area) may be determined using the service provider data received by the one or more processor(s) 212. This data may be the service provider data most recently received by the one or more processor(s) 212 from the provider computing devices 240 within the geographical region. This data may include availability indicators and location data that can be used to determine the number of available provider computing devices 240. For example, referring to FIG. 4, service providers 408, 410 may be located within the supply area 406 but the service provider 410 may be unavailable to provide the service (as he/she may be “offline” or may be occupied with fulfilling a prior request). Service providers 412 may be available to provide the service but may be located outside of the supply area 406. Accordingly, at 306, the number of available provider computing devices 240 may be determined as the number of service providers 408 available to provide the service and located within the supply area 406.

At 306b, a surge value may be determined using the number of available provider computing devices 240 (determined at 306a) and the fee surge for the on-demand service may then be set as the surge value. In various embodiments, the surge value may be determined by determining the surge delta using Equation (3) described above with Sₜ^{available} set as the number of available provider computing devices 240 determined at 306a.

Referring to FIG. 3, the method 300 may further include communicating (at 308) the fee surge to the respective requestor computing device 220 (that transmitted the request for the on-demand service) and to a provider computing device 240. This communication may be for the associated service requestor and the associated service provider to indicate whether to accept provision of the service at the fee surge.

In an exemplary embodiment, the fee surge may first be transmitted from the server 210 to the requestor computing device 220. The fee surge may be displayed to the associated service requestor via the user interface on the requestor computing device 220. The associated service requestor may then indicate whether to accept or reject provision of the service at the fee surge. Requestor preference data indicating the service requestor's acceptance/rejection may then be transmitted to the server 210. Upon receiving indication that the associated service requestor accepts the provision of the service at the fee surge, the one or more processor(s) 212 may then assign one of the available provider computing devices 240 to the request. Assignment data including details of the request (including the fee surge) may be transmitted to the assigned provider computing device 240. Similarly, these details may be displayed to the associated service provider via the user interface on the assigned provider computing device 240 and the service provider may indicate whether to accept or reject providing the service at the fee surge. Provider preference data indicating the service provider's acceptance/rejection may then be transmitted to the server 210. Alternatively, the assignment of one of the available provider computing devices 240 to the request may first be performed and the fee surge may be sent to the requestor computing device 220 and the provider computing device 240 almost simultaneously.

Referring to FIG. 3, the method 300 may further include allocating the associated service provider (e.g. the service provider associated with the above-mentioned assigned provider computing device) to fulfil the request at the fee surge upon receiving indication that both the associated service requestor and the associated service provider accept the provision of the service at the fee surge. This allocation may include transmitting from the server 210, the allocated service provider's details to the requestor computing device 220. The allocated service provider may then proceed to perform the service for the service requestor.

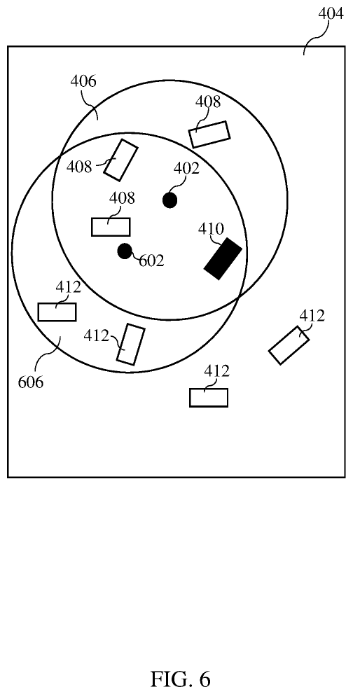

In various embodiments, upon receiving a subsequent request for the on-demand service, the one or more processor(s) 212 of the server 210 may repeat the method 300 for this request. FIG. 6 shows an example of determining another supply area 606 (in the map 404 of FIG. 4) centered around the location 602 where this subsequent request is required. This determination of the supply area 606 may be done using the size parameter in the memory 214. As shown in FIG. 6, the supply area 606 may differ from the supply area 406, and therefore, the service providers 408, 412 identified as available to provide the service and located within the supply area 606 for this request may differ from those for the previous request. Accordingly, the fee surge for this subsequent request may be determined at 306 (with 306a, 306b) using a different number of available provider computing devices 240 and may thus be different from that for the previous request. It is to be noted that although the supply area 406 and the supply area 606 are shown as overlapping in FIG. 6, these supply areas 406, 606 may be distinct areas separated from each other. Further, in some embodiments, the dimension of the supply area indicated by the size parameter in the memory 214 may be different for different requests, as it may be varied according to factors (such as, but not limited to, the time of the day). In some embodiments, the size of the supply area may be based on (e.g. inversely proportional to) a number of available service providers near (e.g. within about 0.5 km of) the location 402, 602 where the request is required.

Although the computational complexity in performing 306 may be higher when determining the supply area using the size parameter (as opposed to determining it as one of the predefined geohashes), the surge oscillation may be reduced and therefore, less computational resources may be consumed in the long run. Reducing the surge oscillation may also help to increase the overall allocation rate, reduce overall cancellation rate and improve user experience for the service requestors. In particular, as the supply area (e.g. 406/606 of FIG. 6) may be larger than the geohash, the average distance between the service providers within the supply area may be higher and the likelihood of collusion among the service providers may decrease. Further, the number of available provider computing devices 240 may be higher in the larger supply area. Referring to Equation (3), as Sₜ^{available} increases, the surge delta may decrease. With a greater and more consistent supply of service providers, the confidence of having enough supply to meet the demand may be higher, and thus, in balancing the demand and supply, it may not be necessary to adjust the fee surge by huge amounts. Also, the proportion of gaming service providers in relation to the total number of service providers may decrease and thus, the behavior of these gaming service providers may affect the change in the surge to a lesser extent. For example, given a same number of gaming service providers, the proportion of gaming service providers may be lower if the total number of service providers increases. These can in turn reduce the surge oscillation within the supply area over time (e.g. referring to FIG. 4, the surge for a request required at the location 402 may oscillate less over time). Further, referring to FIG. 6, the locations 402, 602 may be sufficiently near to each other to be in a same geohash. However, the supply areas 406, 606 may differ and hence, the available service providers 408, 412 may also differ. Accordingly, even if the service provider 408 within the supply area 406 but outside the supply area 606 attempts to game the surge mechanism, such behavior may at most affect the surge oscillation for the location 402 but not for the location 602, and hence, the surge oscillation for the location 602 can be reduced.

In various embodiments, at 306, the surge value (which the fee surge is set as) may be determined using a weighted function of the number of available provider computing devices 240. In particular, the nearer an available service provider is to the location where the on-demand service is required, the higher the likelihood the service provider can provide better quality service to the service requestor and hence, a higher weight may be associated with the provider computing device 240 of this service provider. For example, a driver nearer a user requiring transportation service can reach the user faster, hence reducing the waiting time for the user. Accordingly, the weighted function may include weights associated with respective available provider computing devices 240. Each weight may be related to a distance between a location of the associated available provider computing device 240 and a center of the supply area. This supply area may be a geohash or may be determined with the size parameter in the memory 214.

In particular, as described above, the geographical region may be divided into a plurality of geohashes in some embodiments and a surge value may be periodically determined for each geohash based on the number of available provider computing devices 240 within the geohash. A weighted function of this number of available provider computing devices 240 may be used for determining the surge value. Each weight may be related to a distance between a location of the associated available provider computing device 240 and a center of the geohash (where the bulk of the demand may be near). When the supply area is determined as the geohash in which the location where the on-demand service is required lies, the center of this geohash may be the center of the supply area and thus, each weight for determining the surge value of this geohash (the surge value which the fee surge may be set as) may be considered as related to a distance between a location of the associated available provider computing device 240 and a center of the supply area. This center of the supply area need not coincide with the location where the on-demand service is required.

Alternatively, the supply area may be determined as an area having the particular dimension indicated by the size parameter. In these embodiments, the surge value (which the fee surge may be set as) may also be determined using a weighted function of the number of available provider computing devices 240 within the supply area. Each weight may similarly be related to a distance between a location of the associated available provider computing device 240 and a center of the supply area. However, the center of the supply area may coincide with the location where the on-demand service is required.

In various embodiments, the above-mentioned weighted function used for determining the surge value may alternatively be referred to as a supply weightage decay function. In some embodiments, the weighted function may be a linear function as shown in Equation (5) below.

$$w ( d ) = 1 - \frac{d}{D} \qquad ( 5 )$$

where w(d) represents a weight associated with an available provider computing device 240 located at a distance d from the center of the supply area, and D represents a maximum distance from the center to the boundary of the supply area. For example, D may be equal to the radius r for a circular supply area.

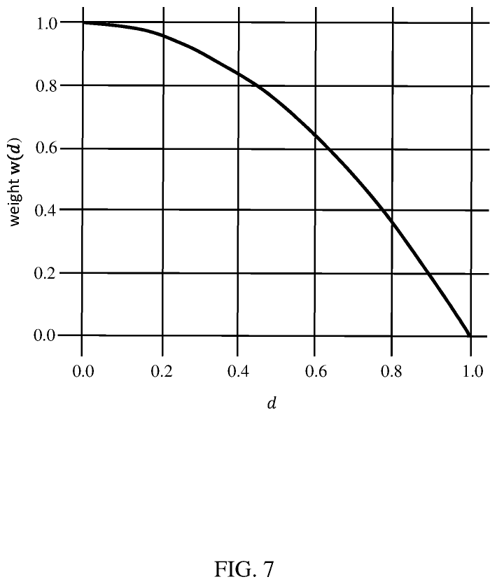

Alternatively, the weighted function w(d) may be a quadratic alliterative function as shown in Equation (6) below. Using a quadratic alliterative function may more accurately differentiate the quality of service that can be provided by the various service providers, as there may be less difference in the quality among the service providers within a sufficiently small distance from the center of the supply area. FIG. 7 shows a graph plotting the output of the weighted function w(d) of Equation (6) against the distance d.

$$w ( d ) = \sqrt{1 - {( \frac{d}{D} )}^{2}} \qquad ( 6 )$$

However, the weighted function w(d) may be any function as long as the output of the weighted function w(d) is 1 when the service provider is at the center of the supply area and 0 when the service provider is at the boundary of the supply area, and the variable d ranges from zero to the distance D i.e. 0≤d≤D.

In some embodiments, there may be an oversupply of service providers within a supply area determined (at 304) using the size parameter. In these embodiments, the supply area may be reduced in size upon determining that the number of available computing provider devices 240 (determined at 306a) within the supply area is greater than a maximum supply threshold. This reduction may be performed once or may be performed repeatedly until the number of available provider computing devices 240 becomes lower than the maximum supply threshold. For example, after determining the number of available provider computing devices 240 within the supply area at 306a, this number may be compared with the maximum supply threshold. If this number is greater than the maximum supply threshold, the supply area may be reduced in size. The determination of the number of available provider computing devices 240 within the reduced supply area and the comparison of this number with the maximum supply threshold may be performed again. If this number is again greater than the maximum supply threshold, the supply area may again be reduced in size. This reduction in size of the supply area, determination of the available provider computing devices 240 in the supply area and comparison of this number with the maximum supply threshold may be repeated until it is determined that the number of available provider computing devices 240 in the supply area is lower than the maximum supply threshold. In various embodiments, the size of the supply area may be reduced by approximately 5% to approximately 10% each time. In some embodiments, after such adjustment of the supply area, if the size of the supply area is lower than a minimum size threshold, the weights (for determining the surge value) associated with each available provider computing device 240 within the supply area may be equal, or in other words, the weighted function may be w(d)=1 for all d.

In some embodiments, the one or more processor(s) 212 of the server 210 may further determine a distance between the boundary of the supply area and each provider computing device 240 associated with a service provider available to provide the service but located outside the supply area. If the determined distance is lower than a distance threshold, the provider computing device 240 may be considered as an available provider computing device 240 within the supply area (when determining the fee surge at 306 of method 300). This is because an available service provider outside of the supply area may enter the supply area in a next time instance and thus, may be within the supply area when or soon after performing 308-310 of method 300. In some embodiments, the one or more processor(s) 212 of the server 210 may further determine an estimated route of the available service provider over multiple subsequent time instances (based on for example, a direction the service provider is facing and/or an average speed of the service provider). In these embodiments, a further condition for the provider computing device 240 to be considered as being within the supply area may be that the estimated route intersects with the supply area.

As mentioned above, the one or more processor(s) 212 of the server 210 may periodically receive updated service provider data from a plurality of provider computing devices 240 within the geographical region where the on-demand service may be provided. In particular, updated service provider data may be received at each time instance tₛₚ of a plurality of successive time instances and the memory 214 of the server 210 may store the received service provider data at each time instance tₛₚ.

In various embodiments, a request for the on-demand service may be received at a particular time T and the one or more processor(s) 212 may determine the fee surge (at 306 of method 300) based on the service provider data received at the most recent time instance t_{sp,recent} nearest to the time T and the service provider data received at one or more time instances t_{sp,recent}−2, t_{sp,recent}−1 prior to the most recent time instance t_{sp,recent}. This service provider data may include availability indicators and location data of provider computing devices 240 within the geographical region.

As described above, in some embodiments, the geographical region may be divided into a plurality of geohashes and a surge value may be determined periodically for each geohash. The fee surge may then be set as the most recently determined surge value for the geohash which the supply area is determined as (hereinafter, referred to as the “supply geohash”). In some embodiments, the surge value determined at a particular time point x for each geohash (e.g. the supply geohash) may be determined based on a number of available provider computing devices 240 within the geohash (e.g. supply geohash) at the particular time point x and a number of available provider computing devices 240 within the geohash (e.g. supply geohash) at time points x−1, x−2, x−3 etc. prior to the particular time point x. The number of available provider computing devices 240 within the geohash in each time point x may be determined from the service provider data received in the time instance tₛₚ prior to and nearest to the time point x. Accordingly, when a request is received at a particular time T, the fee surge may be set as the most recently determined surge value (i.e. the surge value determined at time point x nearest to the particular time T) for the supply geohash. This surge value may in turn be determined based on the service provider data received at the most recent time instance t_{sp,recent} nearest to the time point x (in other words, nearest to the particular time T) and the service provider data received at one or more time instances t_{sp,recent}−2, t_{sp,recent}−1 etc. prior to this most recent time instance t_{sp,recent}.

In some embodiments where the supply area may be determined using the size parameter in the memory 214, the fee surge may be set as the surge value determined based on the number of available provider computing devices 240 within the supply area determined from the most recently received service provider data and also, the number of available provider computing devices 240 within the supply area determined from the service provider data received prior to this. In other words, when the request is received at a particular time T, the fee surge may be determined based on the service provider data received at the most recent time instance t_{sp,recent} prior to and nearest to the particular time T and the service provider data received at one or more time instances t_{sp,recent}−2, t_{sp,recent}−1, etc. prior to this most recent time instance t_{sp,recent}.

In some embodiments, the fee surge may be determined (at 306) by performing a temporal smoothing of the supply. In particular, the fee surge may be determined using a weighted function of the service provider data received at the most recent time instance t_{sp,recent} and the service provider data received at each of the one or more time instances t_{sp,recent}−2, t_{sp,recent}−1, etc. prior to this most recent time instance t_{sp,recent} In particular, the weighted function may be a weighted average function of the number of available provider computing devices 240 within the supply area in the most recent time instance t_{sp,recent} and in each time instance t_{sp,recent}−2, t_{sp,recent}−1, etc. prior to this. For example, the weighted average function may include weights associated with respective time instances, with each weight related to a difference between the respective time instance and the most recent time instance t_{sp,recent}. In particular, a higher weight may be associated with a time instance nearer to the most recent time instance t_{sp,recent}.

In one example, the weighted average function may be a weighted moving average function and may use the service provider data stored for the previous five time instances (e.g. previous five minutes). In this example, the fee surge may be determined using Equation (3) with a weighted number of available provider computing devices 240 (Sₜ^{available}) determined with Equation (7) below.

$${S}_{t}^{available} = \frac{{\sum }_{n = t - 4}^{t} {nS}_{n}^{available}}{{\sum }_{n = t - 4}^{t} n} \qquad ( 7 )$$

where Sₙ^{available} represents a number of available provider computing devices 240 within the supply area at time instance n and where Sₙ^{available} may be determined from the service provider data received at a time instance tₛₚ prior to and nearest to n.

In another example, the weighted average function may be an exponentially weighted average function and the fee surge may be determined using Equation (3) with a weighted number of available provider computing devices 240 (Sₜ^{available}) determined with Equation (8) below.

$${S}_{t}^{available} = \frac{{\sum }_{n = t - 4}^{t} {( 1 - α )}^{t - n} {S}_{n}^{available}}{{\sum }_{n = t - 4}^{t} {( 1 - α )}^{t - n}} \qquad ( 8 )$$

where α represents a discount factor and α>0. Compared to Equation (7), the differences in weights associated with successive time instances may be greater when Equation (8) is used to determine Sₜ^{available}.

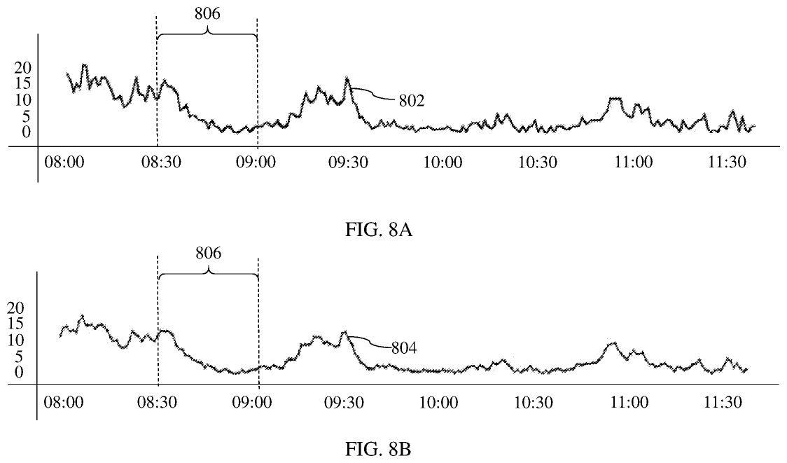

FIG. 8A shows an actual number of available provider computing devices 240 over a time period between 08:00 and 11:30 and FIG. 8B shows a weighted average number of available provider computing devices 240 over the time period between 08:00 and 11:30, where each weighted average number of available provider computing devices 240 is determined with Equation (8) with α set as 0.5.

In particular, FIG. 8A shows a graph 802 illustrating the actual number of available provider computing devices 240 over the time period and FIG. 8B shows a graph 804 illustrating the weighted average number of available provider computing devices 240 over the time period. As shown in FIGS. 8A and 8B, in the time interval 806 between 08:30 to 09:00, the number of available provider computing devices 240 decreases (which may be due to service providers colluding and going “offline”). In this time interval, the actual number of available provider computing devices 240 can be seen to oscillate more as compared to the weighted average number of available provider computing devices 240. Accordingly, the surge determined using the weighted average number of available provider computing devices 240 may oscillate less. Performing a temporal smoothing of the supply as described above (as opposed to for example, a temporal smoothing of the fees) may reduce the fluctuation in the fee as observed by the service requestors. Such temporal smoothing of the supply may also result in fee surges that help the service providers to more easily make decisions on whether to provide the service. Therefore, the allocation rates may increase.

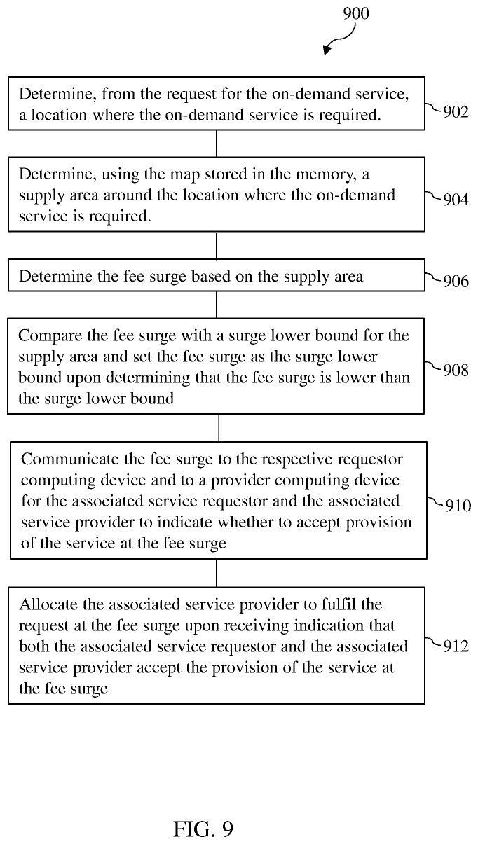

FIG. 9 shows a flowchart of a method 900 of determining a fee surge for an on-demand service according to alternative embodiments. As shown in FIG. 9, the method 900 is similar to the method 300 (with 902-906 and 910-912 corresponding to 302-310 respectively), except that after determining the fee surge (at 906) and before communicating (at 910) the fee surge to the respective requestor computing device 220 and a provider computing device 240, the fee surge may be compared (at 908) with a surge lower bound for the supply area and set as the surge lower bound upon determining that the fee surge is lower than the surge lower bound. The supply area may be a geohash or an area determined with the size parameter as described above.

In some embodiments, the surge lower bound for the supply area may be determined by the one or more processor(s) 212 based on a plurality of historical allocation rates. Each historical allocation rate may correspond to a respective fee surge and may be representative of a number of fulfilled requests for the on-demand service at the respective fee surge during one or more historical time intervals in an area characteristically similar to the supply area. In some embodiments, the one or more processor(s) 212 may determine, from the request for the on-demand service, a time interval of interest during which the on-demand service is required. In these embodiments, the one or more historical time intervals for each historical allocation rate may be characteristically similar to the time interval of interest.

In an exemplary embodiment, the surge lower bound for the supply area may be determined as a minimum of the fee surges corresponding to the historical allocation rates above a percentile threshold. This minimum of the fee surges may represent the lowest surge the service providers are willing to accept before agreeing to provide the service. In various embodiments, the percentile threshold may range from 10% to 80% and may range from 30% to 60% in some exemplary embodiments.

For example, an allocation rate β in a supply area gᵢ during a time interval of interest Tᵢₙₜ may be a function A(s_{T}|gᵢ) of a surge s_{T} during the time interval of interest Tᵢₙₜ according to Equation (9) below. The function A(s_{T}|gᵢ) may be a monotonic non-decreasing function (such as, but not limited to, a linear function) and may be determined based on the historical allocation rates during characteristically similar historical time interval(s) in an area characteristically similar to the supply area gᵢ. Tᵢₙₜ may take on any value, such as, but not limited to, 30 minutes, 1 hour or 2 hours.

A(s_{T}|gᵢ)=β (9)

Accordingly, the minimum surge s_{T}^{p} for the allocation rate in the supply area gᵢ to be at least a percentile threshold β^{p} during the time interval of interest Tᵢₙₜ may be determined according to Equation (10). In other words, the minimum surge s_{T}^{p} to achieve a scenario where at least (100−β^{p})% of service requests are fulfilled may be determined according to Equation (10). The surge lower bound for the time interval of interest Tᵢₙₜ and for the supply area gᵢ may thus be determined as the minimum surge s_{T}^{p}.

s_{T}^{p}|gᵢ=A⁻¹(β^{p}) (10)

For example, if A(s_{T}|gᵢ) is a linear function as shown in Equation (11), then s_{T}^{p} may be determined according to Equation (12) below.

$$A ( {s}_{T} \vert {g}_{i} ) = {as}_{T} + b \qquad ( 11 )$$

$${s}_{T}^{p} \vert {g}_{i} = {A}^{- 1} ( {β}^{p} ) = \frac{{β}^{p} - b}{a} \qquad ( 12 )$$

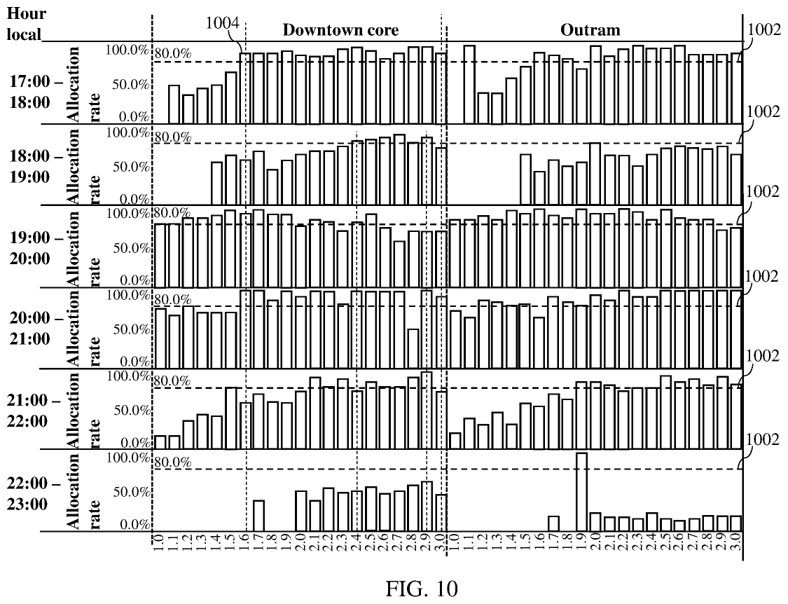

FIG. 10 shows an example of setting the surge lower bound based on historical allocation rates. In particular, FIG. 10 shows twelve bar charts, each corresponding to a respective one hour time interval (17:00-18:00, 18:00-19:00, 19:00-20:00, 20:00-21:00, 21:00-22:00, 22:00-23:00). Each bar chart further corresponds to one of two areas “Downtown core” and “Outram”. At these two areas in Singapore, the hours from 17:00 to 19:00 may be considered as evening peak hours where demand is typically high. In particular, in FIG. 10, each bar of each bar chart represents a historical allocation rate (y-axis) at a respective fee surge (x-axis) in the corresponding area and during the corresponding one hour time interval.

Each historical allocation rate shown in FIG. 10 may be determined based on a number of fulfilled requests in a single historical time interval characteristically similar to the corresponding one hour time interval or on a number of fulfilled requests in multiple historical time intervals characteristically similar to the corresponding one hour time interval. For example, the historical allocation rate 1004 (at a surge of 1.6 in the time interval from 17:00 to 18:00) as shown in FIG. 10, may be determined based on a number of fulfilled requests at a surge of 1.6 between 17:00-18:00 on a previous weekday (a single historical time interval). Alternatively, it may be based on a total number of fulfilled requests between 17:00-18:00 from Monday to Friday over the past three weeks (multiple historical time intervals). For the latter, a percentage of service requests fulfilled from Monday to Friday each week may be determined and the historical allocation rate may be determined as an average of these percentages. Alternatively, the historical allocation rate may be derived by determining the percentage of service requests fulfilled (out of the total number of service requests in the three weeks).

As shown in FIG. 10, a percentile threshold 1002 of 80% may be set for determining the surge lower bound. Referring to the bar chart illustrating the historical allocation rates in “Downtown core” in the time interval of 17:00-18:00, the fee surges corresponding to historical allocation rates greater than 80% range from 1.6 to 3.0. Therefore, the surge lower bound for 17:00-18:00 in “Downtown core” may be determined as a minimum of this range, or in other words, 1.6. Similarly, referring to the bar chart illustrating the historical allocation rates in “Downtown core” in the time interval 18:00-19:00, the fee surges corresponding to historical allocation rates greater than 80% range from 2.4 to 2.9 (as there is typically a greater demand between 18:00-19:00 as compared to 17:00-18:00). Therefore, the surge lower bound for 18:00-19:00 in “Downtown core” may be determined as a minimum of this range, or in other words, 2.4. Referring to the bar chart illustrating the historical allocation rates in “Downtown core” from 19:00-20:00, it can be seen that at this time, the first wave of high demand has passed and more drivers have arrived in or near this area. Accordingly, between 19:00-20:00, a surge lower bound may not be set and the fee surge may be determined using Equation (3) and allowed to fluctuate between 1.0 and 3.0.

As mentioned above, each historical allocation rate may be representative of a number of fulfilled requests in multiple historical time intervals characteristically similar to the time interval of interest. However, these multiple historical time intervals may have different characteristics similar to the time interval of interest. For example, the historical time intervals for each historical allocation rate may include a first set of historical time intervals having a first characteristic similar to the time interval of interest and a second set of historical time intervals having a second characteristic similar to the time interval of interest, where the first characteristic may differ from the second characteristic. It is understood that the historical time intervals may include any number of sets of time intervals, with each set having a characteristic similar to the time interval of interest but different from the characteristic of another set.

For example, the historical time intervals used for determining a surge lower bound for the time interval 17:00 to 18:00 on a weekday may include a first set of historical time intervals 17:00 to 18:00 from Monday to Thursday over a most recent month. In other words, this first set of time intervals has a first characteristic (weekday) similar to the time interval of interest. This first characteristic may be referred to as a long term pattern characteristic since it may be present over a long period of time (e.g. a weekday is present every week).

Assuming that the above-mentioned particular weekday for which the surge lower bound is to be determined falls in a week immediately after a natural disaster or in a week in a middle of an epidemic outbreak, the historical time intervals may further include a second set of time intervals 17:00 to 18:00 from Monday to Thursday over a month after a similar natural disaster or in a middle of a similar epidemic outbreak. In other words, this second set of time intervals has a second characteristic (natural disaster or epidemic outbreak) similar to the time interval of interest. This second characteristic may be referred to as a short term pattern characteristic since the second characteristic may be present over only a limited period of time (e.g. an epidemic outbreak may last only a few months).

Assuming that an event (such as but not limited to, a concert or a sport event) is held during the time interval 17:00 to 18:00 in the supply area on the above-mentioned particular weekday, the historical time intervals may further include a third set of historical time intervals. This third set of historical time intervals may be 17:00-18:00 of each day over multiple years on which a similar event is held during a similar timing on that day. In other words, this third set of time intervals has a third characteristic (event) similar to the time interval of interest. This third characteristic may be referred to as an event characteristic.

The surge lower bound may be determined using all three above-mentioned sets of historical time intervals. Alternatively, the surge lower bound may be determined based on only two out of the three sets of historical time intervals, for example, the first and second sets. In some embodiments, each historical allocation rate for determining the surge lower bound for the time interval of interest may be determined using a weighted function of different rates, for example, a weighted function of a first rate and a second rate, where the first rate may be determined using the number of fulfilled requests at the respective fee surge during the first set of time intervals and the second rate may be determined using the number of fulfilled requests at the respective fee surge during the second set of time intervals. Each of these first and second rates may be derived by either taking an average of the percentages of fulfilled requests across all the time intervals in the set or by determining the percentage of service requests fulfilled out of the total number of service requests in all the time intervals.

In one example, each historical allocation rate R_{A,his} for determining a surge lower bound for the time interval of interest may be determined using a weighted sum of the first rate R_{A1,his} derived from the first set of time intervals and the second rate R_{A2,his} derived from the second set of time intervals according to Equation (13) below.

R_{A,his}=w₁R_{A1,his}+w₂R_{A2,his} (13)

where w₁ represents a first weight associated with the first rate R_{A1,his} and w₂ represents a second weight associated with the second rate R_{A2,his}. It is understood that each historical allocation rate R_{A,his} may be determined using a weighted function (e.g. weighted sum) of more than two rates derived from more than two sets of time intervals having different characteristics, where the weighted function comprises weights associated with respective ones of the rates.

In some embodiments, the surge lower bounds may be predetermined (prior to performing method 300) using the historical allocation rates as mentioned above and stored in the memory 214. For example, for each geohash of multiple geohashes, a surge lower bound may be generated for each time interval of a plurality of time intervals and stored. The surge lower bounds may be updated periodically based on most recent historical allocation rates.

In some embodiments, the on-demand service may include a variable indicating a type of tool for performing the on-demand service. For example, the on-demand service may be a taxi service and the variable may indicate a taxi type. Different surge lower bounds may be determined for different values of the variable (e.g. different taxi types).

In one example, the following may be performed at 908 of method 900 for a taxi service. In this example, the geographical region may be divided into a plurality of geohashes G={g₁, g₂, . . . gₙ} and at 906, the fee surge s_{T}^{gsupply} for the supply area g_{supply} may be determined as the predetermined surge value for the geohash in which the location where the on-demand service is required lies. In this example, the one or more processor(s) 212 of the server 210 may be referred to as a surge engine that runs a streaming application including instructions to perform method 900.
1. For each taxi type indicated by an identifier ID and for each geohash G={g₁, g₂, . . . gₙ}, determine a surge lower bound S_{T,gi}^{p} for each time interval of a plurality of time intervals (e.g. one hour time intervals), and store these surge lower bounds S_{T,gi}^{p} in the memory 214. Accordingly, the low level implementation of the operation may be partitioned by taxi type for distributed calculation.
2. Input the fee surge s_{T}^{gsupply} (determined at 906) into the surge engine via an independent configuration data stream that may update the current state of the streaming application (in particular, update the fee surge for the supply geohash g_{supply} to become s_{T}^{gsupply}).
3. Determine the fee surge s_{FINAL}^{gsupply} or the supply geohash g_{supply} according to Equation (14) below and update the fee surge for the supply geohash g_{supply} to become s_{FINAL}^{gsupply}. In Equation (14), S_{T,gsupply}^{p} represents the surge lower bound determined for the supply geohash.

s_{FINAL}^{gsupply}=max(s_{T}^{gsupply},s_{T,gsupply}^{p}) (14)

In some embodiments, the memory 214 may include a fixed surge lower bound and a fixed surge upper bound stored therein. In some embodiments, the one or more processor(s) 212 may compare a number of service requests per time interval (e.g. 1 hour) of a day (e.g. a weekday) with a number of service requests per time interval of a previous characteristically similar day (e.g. a previous weekday). Upon determining that the number of service requests per time interval of the day is abnormally low or high, the one or more processor(s) 212 may use the fixed surge lower and upper bounds stored in the memory 214 to determine the fee surge, instead of using the surge lower bound based on historical allocation rates. Alternatively, upon detecting such abnormality, the one or more processor(s) 212 may prompt a user of the server 210 to input surge lower and upper bound(s) via the server's 210 user interface and use these bounds to determine the fee surge. In one example, the number of service requests per time interval of the day may be considered abnormal if a difference between it and the number of service requests per time interval of the previous characteristically similar day is greater than a normal supply threshold.

The inventors of this application have observed that the sensitivity of service requestors to surges in fees tend to be low, especially at certain locations and times of the day. For example, when a service requestor requires a transportation service in a high demand area during a peak hour (where demand for the service is usually high), he/she is likely to accept the provision of the service as long as the fee surge increases by less than a certain amount. This may be due to the service requestor's urgency in requiring the service or a lack of alternative options for the service requestor. In general, it was observed that service requestors appear to understand that fees tend to be higher during peak hours and seem to be willing to accept higher fees during such hours as long as the surge in the fee is reasonable.

Further, one possible reason why service providers collude to take advantage of the surge mechanism is that they generally want to make adequate earnings after deducting their regular expenses (such as fuel expenses and car maintenance expenses for providers of transportation services). Typically, the fee surges form a large proportion of the service providers' income. Therefore, service providers usually set an income target (which may be proportional to the total fee including the surge that can be earned for each request). The service providers are also aware that there is a limit to the number of service requests they can fulfil in the time period during which demand is high, and therefore, may try to take advantage of the surge mechanism to achieve their income target if the fee surge is too low.

Thus, by comparing the fee surge with a surge lower bound and adjusting the fee surge based on the comparison, the possibility of meeting the service providers' income targets without the service providers colluding with one another may increase. In turn, the incentive for the service providers to collude may decrease. Therefore, the surge oscillation may decrease. With a minimum fee surge, service providers may also be more inclined to provide the service and hence, the allocation rate (representative of the number of fulfilled requests) may increase.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A server configured to determine a fee surge for an on-demand service, the server comprising one or more processor(s) configured to receive a plurality of requests for the on-demand service from respective requestor computing devices associated with respective service requestors and further configured to receive service provider data from a plurality of provider computing devices associated with respective service providers; and
a memory comprising a map and instructions stored therein, the instructions when executed by the one or more processor(s), cause the one or more processor(s) to perform the following upon receiving each request for the on-demand service:
determine, from the request for the on-demand service, a location where the on-demand service is required;
determine, using the map stored in the memory, a supply area around the location where the on-demand service is required;
determine the fee surge based on the supply area;
compare the fee surge with a surge lower bound for the supply area and set the fee surge as the surge lower bound upon determining that the fee surge is lower than the surge lower bound;
communicate the fee surge to the respective requestor computing device and to a provider computing device for the associated service requestor and the associated service provider to indicate whether to accept provision of the service at the fee surge; and
allocate the associated service provider to fulfil the request at the fee surge upon receiving indication that both the associated service requestor and the associated service provider accept the provision of the service at the fee surge;
wherein the surge lower bound for the supply area is determined based on a plurality of historical allocation rates, wherein each historical allocation rate corresponds to a respective fee surge and is representative of a number of fulfilled requests at the respective fee surge during one or more historical time intervals in an area characteristically similar to the supply area.

2. The server of claim 1,
wherein the one or more processor(s) further determine, from the request for the on-demand service, a time interval of interest during which the on-demand service is required; and
wherein the one or more historical time intervals for each historical allocation rate are characteristically similar to the time interval of interest.

3. The server of claim 2, wherein the one or more historical time intervals for each historical allocation rate comprise a first set of historical time intervals having a first characteristic similar to the time interval of interest and a second set of historical time intervals having a second characteristic similar to the time interval of interest, and wherein the first characteristic differs from the second characteristic.

4. The server of claim 3, wherein each historical allocation rate is determined by:
determining a first rate using the number of fulfilled requests at the respective fee surge during the first set of time intervals;
determining a second rate using the number of fulfilled requests at the respective fee surge during the second set of time intervals; and
determining the historical allocation rate using a weighted function of the first rate and the second rate.

5. The server of claim 1, wherein the surge lower bound for the supply area is determined as a minimum of the fee surges corresponding to the historical allocation rates above a percentile threshold.

6. The server of claim 1, wherein the map stored in the memory comprises a plurality of geohashes and wherein the supply area is determined as the geohash within which the location where the on-demand service is required lies.

7. The server of claim 6, wherein for each geohash, a surge value is periodically determined, wherein the surge value is determined at a particular time point based on a number of available provider computing devices associated with service providers available to provide the on-demand service and located within the geohash at the particular time point; and
wherein the fee surge is set as the most recently determined surge value for the supply area.

8. The server of claim 1, wherein the memory further comprises a size parameter stored therein, wherein the size parameter indicates a particular dimension of the supply area; and
wherein the supply area is determined, using the size parameter, as an area having the particular dimension and centered around the location where the on-demand service is required.

9. The server of claim 8, wherein the fee surge may be determined based on the supply area by:
determining, using the service provider data, a number of available provider computing devices associated with service providers available to provide the on-demand service and located within the supply area;
determining a surge value based on the number of available provider computing devices; and
setting the fee surge as the surge value.

10. The server of claim 8, wherein the supply area is a circular area and the size parameter indicates a radius of the supply area.

11. The server of claim 7, wherein the surge value which the fee surge is set as, is determined using a weighted function of the number of available provider computing devices;
wherein the weighted function comprises weights associated with respective available provider computing devices, each weight being related to a distance between a location of the associated available provider computing device and a center of the supply area.

12. The server of claim 1, wherein the one or more processor(s) are further configured to periodically receive updated service provider data such that the updated service provider data is received at each time instance of a plurality of successive time instances, and the memory is configured to store the received service provider data at each time instance, and
wherein the request for the on-demand service is received at a particular time and the fee surge is determined based on the service provider data received at the most recent time instance nearest to the particular time the request is received and the service provider data received at one or more time instances prior to the most recent time instance.

13. The server of claim 12, wherein the fee surge is determined using a weighted function of the service provider data received at the most recent time instance and the service provider data received at each of the one or more time instances prior to the most recent time instance.

14. The server of claim 13, wherein the weighted function comprises weights associated with respective time instances, each weight related to a difference between the respective time instance and the most recent time instance.

15. The server of claim 1, wherein the on-demand service comprises an on-demand transportation service.

16. A method of determining a fee surge for an on-demand service, the method comprising:
using one or more processor(s) of a server to:
receive a plurality of requests for the on-demand service from respective requestor computing devices associated with respective service requestors;
receive service provider data from a plurality of provider computing devices associated with respective service providers; and
perform the following upon receiving each request for the on-demand service:
determine, from the request for the on-demand service, a location where the on-demand service is required;
determine, using the map stored in the memory, a supply area around the location where the on-demand service is required;
determine the fee surge based on the supply area;
compare the fee surge with a surge lower bound for the supply area and set the fee surge as the surge lower bound upon determining that the fee surge is lower than the surge lower bound;
communicate the fee surge to the respective requestor computing device and to a provider computing device for the associated service requestor and the associated service provider to indicate whether to accept provision of the service at the fee surge;
allocate the associated service provider to fulfil the request at the fee surge upon receiving indication that both the associated service requestor and the associated service provider accept the provision of the service at the fee surge;
wherein the surge lower bound for the supply area is determined based on a plurality of historical allocation rates, wherein each historical allocation rate corresponds to a respective fee surge and is representative of a number of fulfilled requests at the respective fee surge during one or more historical time intervals in an area characteristically similar to the supply area.

17. A non-transitory computer-readable medium storing computer executable code comprising instructions for determining a fee surge for an on-demand service according to claim 16.

18. A computer executable code comprising instructions for determining a fee surge for an on-demand service according to claim 16.
